(19) United States
(12) Patent Application Publication
(10) Pub. No.: US 2009/0265438 A1
(43) Pub. Date: Oct. 22, 2009

(54) SYSTEM AND METHOD FOR PROVIDING MESSAGING SERVICES IN A MULTI-FUNCTION PERIPHERAL DEVICE

(75) Inventor: Brian Podl, Newport Beach, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/107,650

(22) Filed: Apr. 22, 2008

(51) Int. Cl. G06F 15/16

(52) U.S. Cl. 709/206

(57) ABSTRACT

A multi-function peripheral device (MFP) is configured to receive messages from a mobile device such as a mobile phone. The messages may be received via a network interface on the MFP which communicates with a mobile telephone network. The messages may be text messages which are delivered by the MFP to an output destination.

### BACKGROUND OF THE INVENTION

1. Field of the Invention

This application relates to multi-function peripheral devices (MFPs). More particularly, this application relates to a system and method of providing messaging services between MFPs and devices such as mobile handsets.

2. Description of Related Technology

Current MFPs are not able to receive messages directly from portable handheld devices without using sophisticated processing techniques and/or software. Typically, to send a message to a MFP device from a portable handheld device, an intermediary service must be used to process the message so that the MFP device can receive it. For example, a user wanting to print a text message from their cell phone would need to first send their message via e-mail, and then print the e-mail message on an MFP using e-mail client software installed on a personal computer that accesses the MFP.

### SUMMARY OF CERTAIN INVENTIVE ASPECTS

The system, method, and device of the present invention each have several aspects, no single one of which is solely responsible for its desirable attributes. Without limiting the scope of this invention, several of its features will now be discussed briefly.

In a first embodiment, a multifunction peripheral device (MFP) is provided which includes one or more output modules. The MFP further includes a mobile network interface configured to receive messages sent from a mobile network device, wherein the messages include at least one MFP command. A message handling module is configured to process the received message and transmit the message to a selected one of the output modules.

In a another embodiment, a method of providing messaging services in a multi-function peripheral device (MFP) is provided. The method comprises receiving from a mobile handheld device a message, the message comprising at least one MFP command, and processing the received message to extract the MFP command. The received message is delivered to an output module of the MFP based on the MFP command and an output function is performed on the message.

### BRIEF DESCRIPTION OF THE DRAWINGS

In this description, reference is made to the drawings wherein like parts are designated with like numerals throughout.

FIG. 1 is an example of a network environment suitable for practicing various embodiments described herein.

FIG. 2 is an example of an MMS message which may be sent to the MFP from FIG. 1.

FIG. 3 is an example of the MMS message from FIG. 2 with picture/video data attached to be sent over a network.

FIG. 4 is an example of the MMS message from FIG. 2 with audio data attached to be sent over a network.

FIG. 5 is an example of the MMS message from FIG. 2 with text data attached to be sent over a network.

FIG. 6 is a more detailed block diagram of the MFP from FIG. 1.

FIG. 7 is an example of a message handler that may be used in conjunction with the MFP from FIG. 6.

FIG. 8 is a flowchart of a method of providing messaging services with a MFP.

FIG. 9 is a flowchart providing a general illustration of how an MFP may handle a text message received from a cellular network.

FIG. 10 is a more detailed flowchart of the MFP message handling process.

FIG. 11 is flowchart of a print command process

FIG. 12 is a flowchart of a fax command process.

FIG. 13 is a flowchart of a store command process which stores a message on the MFP device.

FIG. 14 is a flowchart of a store command process which stores a message on an external storage.

FIG. 15 is a flowchart of an e-mail command process.

### DETAILED DESCRIPTION OF CERTAIN INVENTIVE EMBODIMENTS

It has been recognized that many existing mobile devices such as mobile phones are not Internet capable, but are equipped with messaging capability. Some mobile devices are Internet-capable, but users do not take advantage of the capability because the mobile network provider imposes additional charges for access to the Internet. Accordingly, various embodiments disclosed herein provide systems and methods which allow MFPs to receive messages (such as text messages and MMS messages) directly from portable handheld devices, process those received messages, and direct the message output to a specified location. The MFP may output the received messages utilizing its various output capabilities such as printing, faxing, e-mailing, file transfer, and the like.

A portable handheld device may refer to cell phones and other types of handheld devices which are equipped with messaging capabilities such as, for example, simple messaging service (SMS), extended messaging service (EMS), and/or multimedia messaging service (MMS). In general, an MFP device is a single integrated device configured to perform two or more functions, including, without limitation, scanning, copying, printing, taxing, combinations of the same, and the like. The functionality of an MFP device may be accessed over a network, including, for example, the Internet, or a LAN, or at the device itself. An MFP device may be configured with sufficient memory to queue jobs waiting to be processed. It will be appreciated that MFP devices may be configured to perform in a variety of different network and standalone computing environments. Although some of the embodiments described herein relate to an MFP device, other embodiments may be implemented with other peripheral devices, such as single-function devices, including for example printers and scanners. Examples of functions which may be performed by MFPs include, but are not necessarily limited to printing, copying, faxing, telephone, network communication, storage, digital media services (e.g., playing video), and other types of functions.

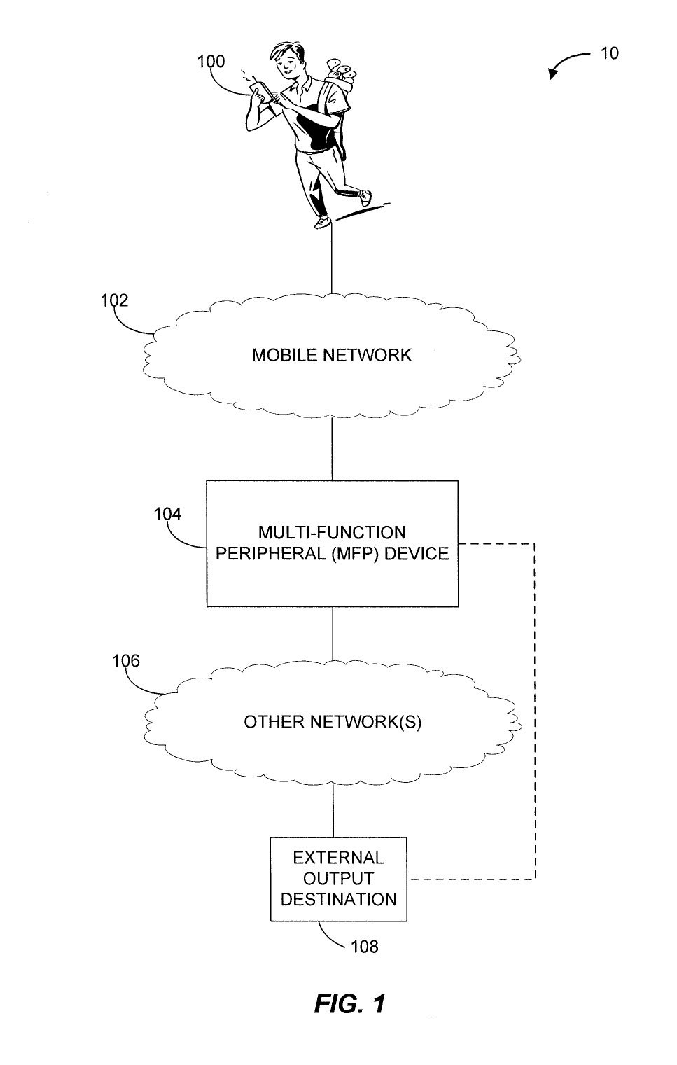

FIG. 1 is a block diagram of a network environment 10 which is suitable for the implementation of various embodiments described herein. The network environment 10 includes one or more network devices 100 which are able to send messages via a mobile network 102. The network devices 100 may take various forms. Typically, a network device 100 is a mobile telephone device that is configured to send messages. However, the network device 100 may also take the form of a general purpose computer such as a personal computer, laptop computer, handheld computer, or some other device that communicates with the mobile network 102.

The mobile network 102 may be a cellular phone network such as a GSM-based network, a CDMA-based network, or a 3^{rd} generation (3G) cellular network which implemented messaging capabilities. The mobile network 102 may also be some other type of network that is capable of relaying messages between devices which communicate with the network. A message may refer to a message that is sent over the mobile network 102 using a text messaging protocol. Examples of text messaging protocols may include, but are not limited to, simple messaging service (SMS), extended messaging service (EMS), and/or multimedia messaging service (MMS).

Also communicating with the mobile network 102 is a MFP device 104. As noted above, an MFP device 104 is a peripheral device which is capable of performing the functions of more than one type of peripheral device. As is known in the art, an MFP device 104 may be configured to output it receives from other devices. For example, an MFP may have a capability to print data that it receives from a computing device that it communicates with over a network or direct connection.

The MFP device 104 may communicate with the mobile network 102 via a network interface. The network interface may be a network card installed in the MFP 104 that is capable of communicating with the mobile network 102. Alternatively, the MFP may be configured to communicate with the mobile network 102 via a gateway provided by another network. The MFP device 104 may also connect to various other networks 106. These other networks 106 may be local area networks (LANs), wide area networks (WANs) such as the Internet, telephone networks such as public switched telephone networks (PSTNs), or some other type of network. In connecting with the other networks 106, the MFP may utilize a network interface card, a modem, or some other type of network access device. Via the other networks 106, the MFP device 104 may send data to one or more external output destinations 108. As will be discussed in detail below, the MFP 104 may be configured to output data to other external output destinations 108 across the other networks 106. Alternatively, the MFP 104 may connect to external output destinations without the use of a network 106, and instead directly connect to the external output destination 108 through a tethered connection such as via a universal serial bus (USB) connection, a Firewire connection, a serial port connection, a parallel port connection, or some other type of direct connection such as wireless, for example.

The output destinations generally may include devices which are configured to receive data from the MFP device 104, and handle the data accordingly to instructions received from the MFP device 104. One exemplary external output destination is a fax machine. For example, an MFP may be configured with a fax capability which allows it to send fax data over a telephone network (which may be one of the other networks 106) to an external output destination 108 which in this particular example is a fax machine device. The MFP 104 may also be configured with an e-mail capability which allows it to output data received by the MFP to an external e-mail account via an e-mail client provided on the MFP 104. Other examples of external output destinations 108 may include external storage devices, external display devices, external printing devices, or some other devices.

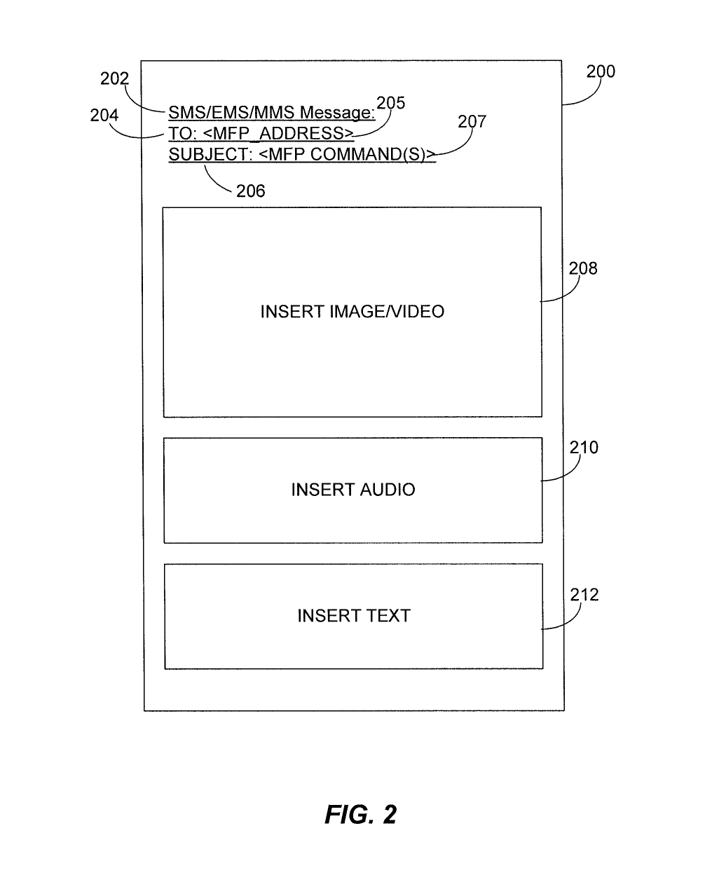

As discussed briefly above, various embodiments relate to MFP device 104 which is configured to receive messages from mobile devices 100 via the mobile network 102. FIG. 2 provides an example of a user interface 200 which may be used to generate a message 202 on a computing device 100 and to send the generated message 202 to an MFP device 104. In this particular example, the interface 200 provides the ability to send a message 202 that may be an SMS message, an EMS message, or an MMS message. As shown in the example user interface 200, the message 202 may be sent to one or more recipients MFPs 104 as specified in the TO: interface element 204. The receiving MFPs may be specified by entering MFP address information 205 in the TO: interface element 204. The message 202 may also include a subject line 206. The subject line 206 may receive command input 207 specified by the user or determined by the computing device 100. The command input 207 is used to specify how the destination MFP 104 should handle the message payload. For example, if the payload is an SMS text message, the command input 207 may specify that the MFP 104 should print the message 202 upon receipt. Because the interface 200 allows a user to send various types of messages (SMS/EMS/MMS), it may include distinct interface windows which allow a user to select the type of data to include in the message.

If the user wishes to send an MMS message that includes image data or video data, a picture selection interface element 208 is provided which allows for the selection of an image or video file to include in the message 202 payload. Similarly, if the user wishes to send an audio file via MMS, an audio selection interface element 210 provides the ability to select an audio file to send as the payload for the message 202. A text input interface element 212 is also provided which allows the user to input text which may be sent via EMS or SMS in the message 202 payload.

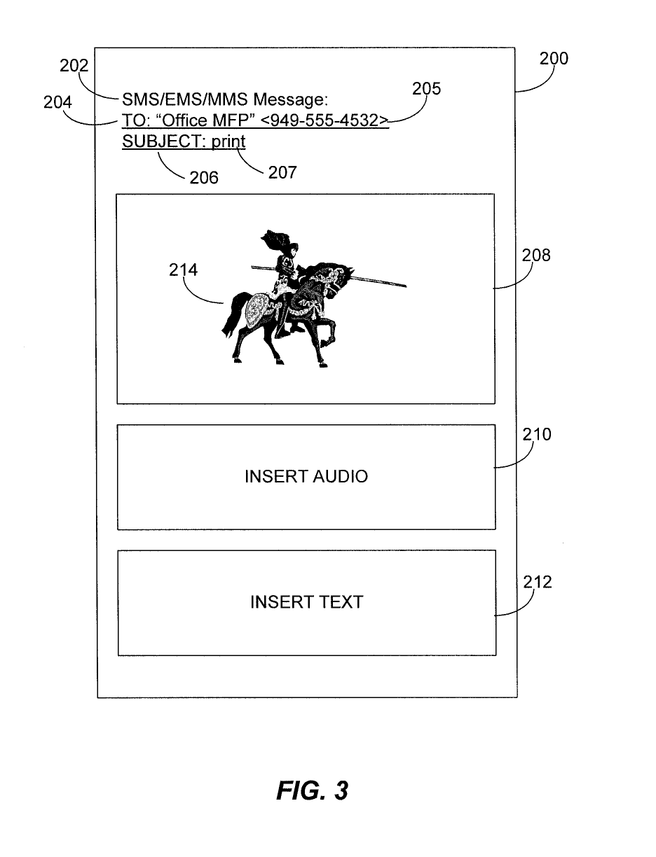

FIGS. 3-5 provide examples of the types of data that are typically sent via the interface elements 208, 210 and 212. Referring specifically to FIG. 3, an example of the user interface 200 configured to send an image-based MMS message 202 is provided. As shown in the figure, a selection of an image file 214 has been made and the file 214 uploaded to the image/video interface element 208. Moreover, MFP address information 205 in the form of a telephone number has been provided. In this particular example, the MFP 104 has been configured to have a phone number which is associated with its mobile network interface as is discussed in further detail below. As discussed above, the subject line interface element 206 may be used to deliver MFP command input 207 to the recipient MFP device. In the example shown in FIG. 3, a “print” command has been provided as the command input 207. The “print” command indicates to the receiving MFP 104 that it should print out the payload of the message 202, which in this particular instance is an image file 214.

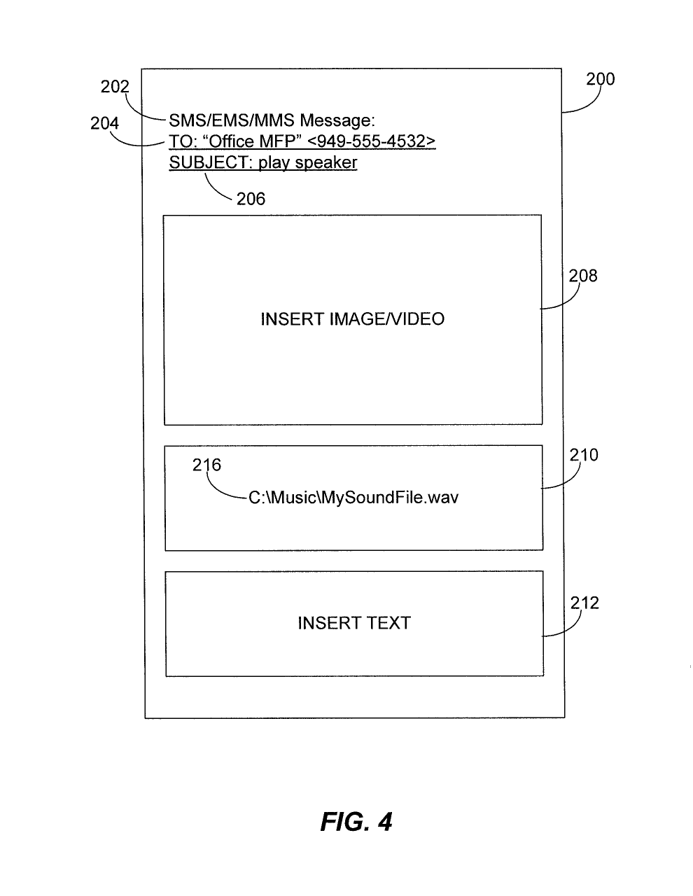

FIG. 4 is an example of the user interface 200 configured to send an audio-based MMS 202. In this example, the user has selected an audio file 216 which is to be sent from the device 100. MFP address information 205 has been input into the TO: interface element 204 which specifies a phone number associated with the MFP 104. As with the example provided in FIG. 3, the subject line interface element 206 includes MFP command input 207. In this example, the command indicates to the receiving MFP 104 that it is to handle the payload by playing the contents of the audio file 216 received in the message 202 payload using a speaker on the MFP 104 as an output device. In other embodiments, different output devices may be specified in the command data 207. For example, the “play” command could specify that the output should be played through a handset on the MFP device 104. A “play handset” command may instruct the MFP 104 to ring its telephone ringer and play the audio file 216 when a user picks up the handset of the device 104. Other commands may be specified for the audio file 214.

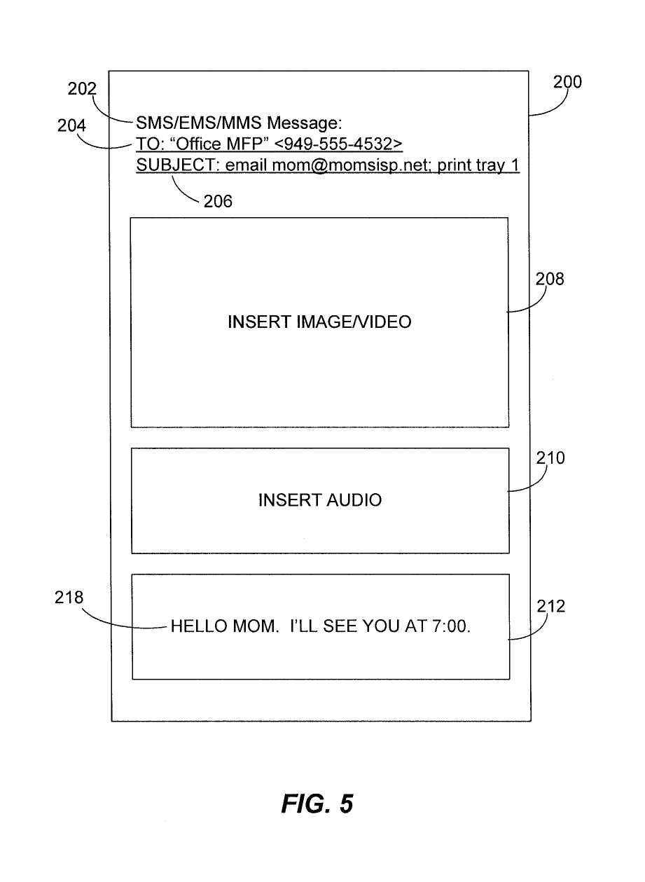

Referring now to FIG. 5, an example of the user interface configured to send a text-based message 202 is provided. A text message 218 is input into the text input interface element 212 as shown. In this example the text-based message 202 is an SMS message. Alternatively, the message may be an EMS message, or some other text-based text messaging protocol. In this example two different commands are specified for the MFP 104. The first command, which reads “email mom@momsisp.net” instructs the MFP 104 to e-mail the text message to the specified e-mail address parameter. The second command, “print” has been made by the user, the causes the MFP 104 to print the text message on paper in the specified tray.

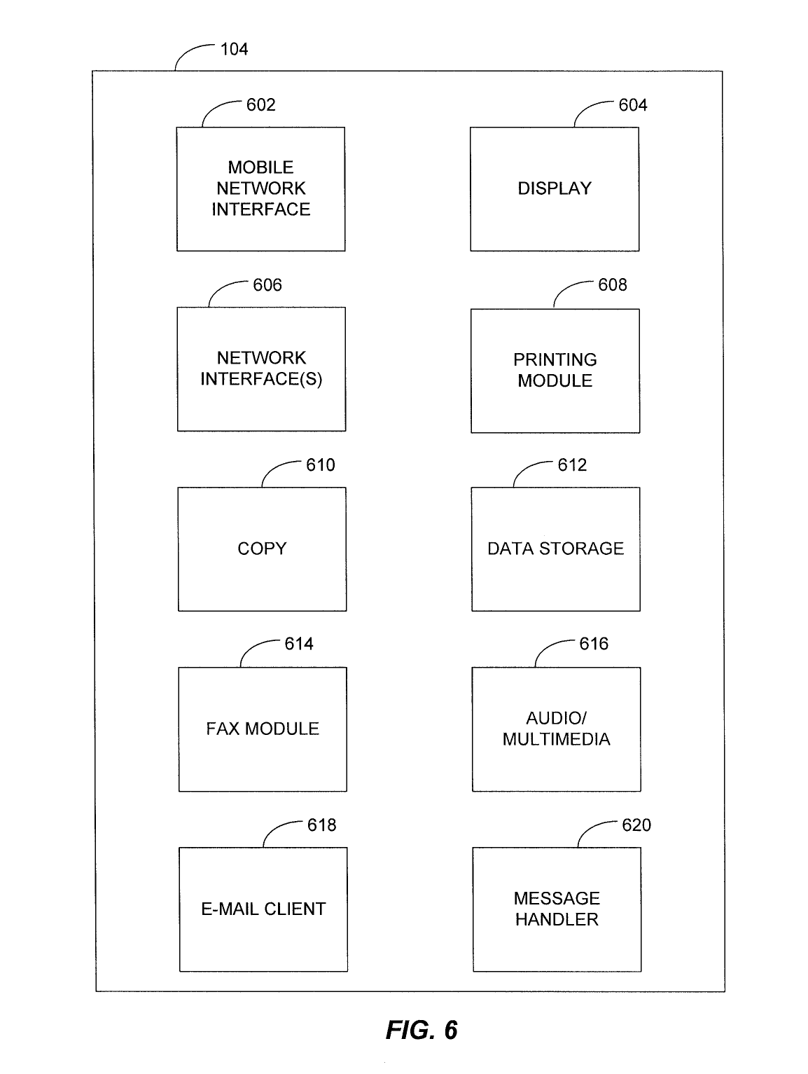

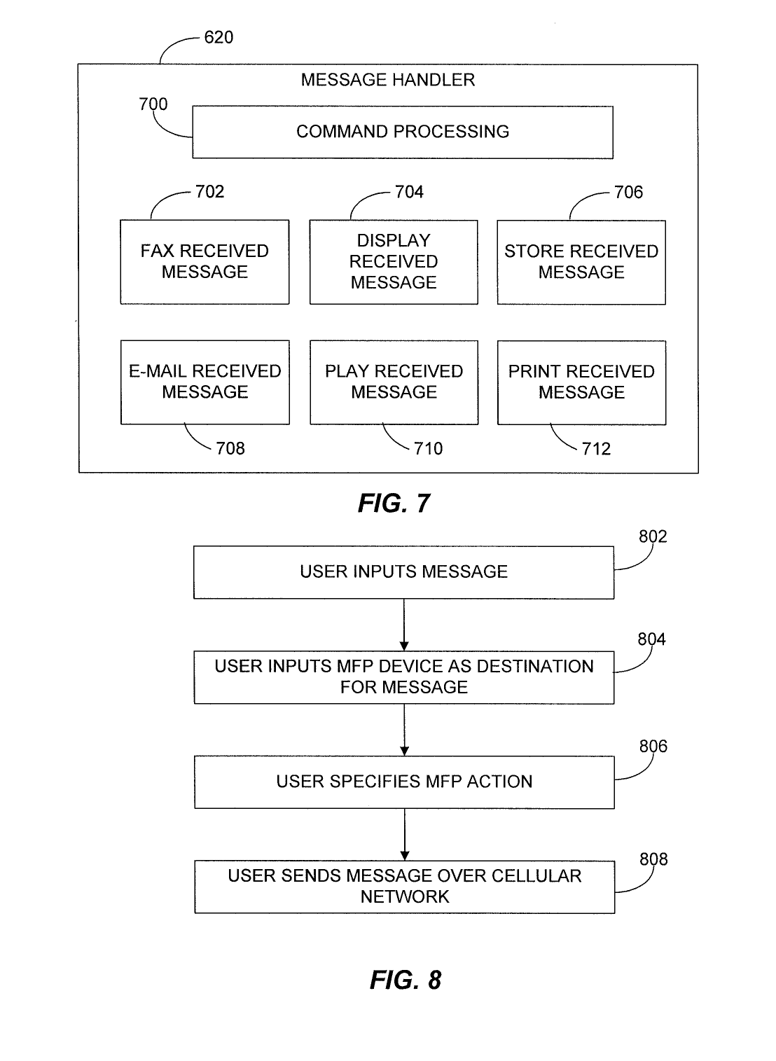

Three specific examples of how a text message 202 may be sent to the MFP 104 are provided in FIGS. 3-5 above. A skilled artisan will appreciate that many different commands may be included with the text message payload, and additional commands are discussed below in connection with FIG. 7. Moving now to FIG. 6, a block diagram is provided which shows a detailed view of the MFP device 104 according to various embodiments described herein. Although specific modules are described in FIG. 6, a skilled technologist will appreciate that not all functional aspects of the MFP 104 are intended to be shown in the block diagram of FIG. 6, but rather shows only those modules and interfaces which are typically used in conjunction with those embodiments described herein. Accordingly, it should be understood that the MFP device 104 may include modules and interfaces not shown in FIG. 6.

The MFP device 104 typically includes a mobile network interface 602. The mobile network interface 602 may be a broadband mobile network access card which allows the MFP 104 to send and/or receive messaging data from the mobile network 102. When messages 202 are sent to an address or phone number associated with the MFP device 104, the device uses the mobile network interface to communicate with the mobile network 102 to receive the message 202. In some embodiments, the mobile network interface 602 may be external hardware that is not part of the MFP device 104. In these embodiments, the mobile network interface may be a standalone receiver that is connected to the MFP device 104. The standalone receiver may be configured to receive the message 202 from the mobile network 102 and transmit the message 202 to the MFP device. In still other embodiments, the MFP device 104 may receive the message data from another MFP device which includes a mobile network interface 602.

The MFP device 104 also may include a display module 604. The display module 604 may take various forms. In some embodiments, the display module includes a simple light-emitted diode (LED) display that provides basic information about the MFP device 104 to the user. In some embodiments, the display may be more sophisticated than a basic LED. For example, the display module 604 MFP 104 may include an LCD display which provides a user interface to access functionality of the device. The user interface may be a touchscreen interface, or some other type of user interface.

The MFP device 104 may also include modules which provide typical MFP functionality. For example, network services may be provided by one or more network interfaces 606. Because the MFP device may connect to various different networks, there may be various network interfaces available on the device 104. For example, one network interface 606 may be an IP network interface that includes a network access card and associated software which allows the device 104 to communicate with an IP network via the TCP/IP protocol (or some other protocol such as UDP, for example). The MFP device may also be configured to access a public switched telephone network (PSTN) in order to provide telephone-based services such as facsimile service. Also included in the MFP device may be a print module 608. The print module 608 includes software and hardware configured to output printed documents from the device 104. The device 104 may also include a copy module 610 for copying documents.

In some embodiments, the MFP 104 may be configured with data storage 612. The data storage 612 may be a volatile or non-volatile memory. In some embodiments, the data storage 612 may be used to store data received via one or both of the mobile network interface 602 and the IP network interface 606. The data storage may be temporary or permanent. The MFP device 104 may also include a fax module 614. The fax module 604 may include hardware and software which works in conjunction with the PSTN network interface 606 to allow the device to send and receive faxes via a telephone network.

Some MFP devices 104 may also include an audio/multimedia module 616. The audio module 616 may take various forms and have various features. For example, in one embodiment, the audio features of the MFP may be limited to providing sound through a handset on the device 104. In other embodiments, however, the audio/multimedia module 616 may include software which allows for multimedia files to be played on the device 104. For example, the device may include speakers which allow the user to output audio files which are stored in the data storage 612. Additionally, the device 104 may include multimedia playing software which may play video files on the display module 604 and output the associated sound through the speakers on the device. Certain MFP devices 104 may also be capable of providing e-mail functionality via an e-mail client 618. The e-mail client may include software which connects with an SMTP service via the network interface 606 to allow the device to send e-mails to recipients on the network. The e-mail client 618 may also include functionality that allows the device 104 to receive e-mail via one or more of any number of known e-mail protocols.

As discussed previously, in various embodiments, the MFP device 104 is configured to receive messages from mobile network devices 100, and process those received messages to output the messages in specified locations. In order to allow the MFP 104 to output the received messages utilizing its output capabilities, it is configured with a message handler 620. The message handler 620 typically take the form of a software module configured to receive messages sent to the device 104 via its mobile network interface 602 and process the received messages accordingly. Turning now to FIG. 7, a detailed block diagram of a message handler 620 is provided which shows various functions that may be deployed to handle incoming received messages.

As shown in the figure, the message handler 620 may include a command processing function 700. The command processing function 700 is generally configured to parse messages received over the mobile network interface 602. In some embodiments, the command processing function 700 extracts command 207 associated with a received message 202. As noted above, the commands 207 may be included with the message 202 by specifying them in the subject line 206 of the message. Of course, in other embodiments, the command 207 could be included with the message payload itself. The command processing function generally processes the received message 202 to extract the requested action to take with respect to the received message, and to further extract any specified parameters related to the requested action. As indicated above, more than one command 207 may be included in a message 202, so the command processing function 700 may be configured to process each command separately. In some embodiments, the command processor may be configured to determine whether the MFP 104 is capable of executing the command requested in the message. For example, if the message includes a play command, but the MFP does not have multimedia output capability, the command processing function may return an error message to the device 100 which sent the message 202.

After processing commands 207 from a message 202, the message handler 620 may be configured to perform an output function in accordance with the processed command 207. In order to perform the output functions, the message handler 620 is typically configured with various message handling capabilities which allow the MFP 104 to perform the requested output operations. For example, the message handler 620 may include a fax received message function 702. The fax received message function 702 is typically called when a message 202 is received with a fax command 207 included in the subject line 206 of the message. The fax received message is configured to utilize the fax module 614 on the device 104 to fax the payload to a specified phone number or other destination.

The message handler 620 may further include a display received message function 704. The display received message function 704 is typically configured to output the message to the display module 604 of the MFP device 104. As noted above, the MFP 104 may have a simple LED display. In such an embodiment, if message 202 is a text message, it can be displayed. However, a multimedia image-based message may be rejected by the display received message function 704, as the LED device may not have the capability to display the image file. It however, the MFP includes a more sophisticated display, such as an LCD monitor, an MMS message would be displayed appropriately.

The message handler 620 may also include a store received message function 706. The store received message function 706 is typically called when the MFP command 207 included in the message 202 is a “store” command which request that the message data be stored in a specified location. Typically, the message is stored in data storage 612. However, in some embodiments, the command 207 may specify a storage location that is not on the device 104 itself, but rather is a storage location (such as a file server, for example) which may be accessed by the device 104 via one of the other networks 106.

Other commands may also be processed by the message handler 620. For example, the message handler 620 may further include an e-mail function 708. The e-mail function 708 may be configured to forward a received message 202 utilizing the e-mail client 618 of the device 104 to an address specified in the command 207 parameters. A play received message function 710 may also be provided. The play function 710 is configured to handle messages 202 having a play command specified in the MFP command 207 associated with the message. The play function 710 typically handles MMS messages which include a video file or audio to be played on the device. The play function 710 may call the audio/multimedia module 616 when the message is received so that the message payload is played on the device 104. Alternatively, a play command may specify a location to play the file that is remote to the MFP device 104. In some embodiments, the received file may be automatically played on the device, while in other embodiments a user intervention may be required to avoid instances where unwanted multimedia content is automatically played on the device without a user's consent. The message handler may also include a print function 712. The print function 712 is typically configured to output the message payload by calling the printing module 608 of the device.

Although the message handler 620 shown in FIG. 7 includes a specific set of functions, a skilled technologist will appreciate that not all of the functions shown in FIG. 7 are necessary for practicing various embodiments. It should be further appreciated that additional output functions may be provided by the message handler, depending upon the output capabilities of the device 104.

Referring now to FIG. 8, a flowchart provides an example of the basic process by which a user may send a message 202 to an MFP device 104 from a computing device 100 via the mobile network 102. The process begins at block 802, where the user inputs a message payload. As noted above, the message may be a text message, a multimedia message, or some other type of message. Next, the user specifies an MFP device 104 as the destination of the message 202 at block 804. As noted above, the MFP device may be associated with a telephone number that is accessible via the mobile network 102. Next, at block 806, the user specifies the action or MFP command 207 that the MFP 104 is to perform with respect to the message 102. As discussed above, various actions may be specified by inputting them into the subject line 206 of the text messaging interface 200 on the mobile device 100. Once the MFP command 207 has been specified by the user, the process then moves to block 808, where user sends the message 202 to the destination device 104.

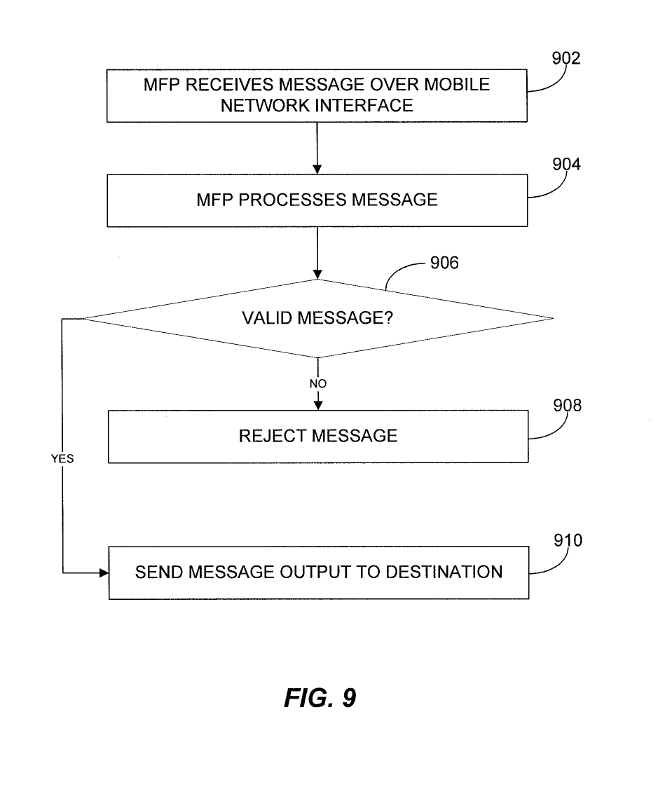

The message sent by the user to the MFP device 104 is received by the device via its mobile network interface 602 and is passed to the text message handler 620 for processing. FIG. 9 is a flowchart showing one example of how the text message handler 620 may process a received message in accordance with one or more embodiments. The process begins at block 902, where the MFP 104 receives the message 202 from the mobile network 102. Next, at block 904, the MFP 104 processes the received message 202. As discussed above, the processing of the message may be performed by the text message handler 620. The process then moves to decision block 906, where the text message handler 620 determines if the message data is valid for the MFP device 104. As part of this process, the message handler may determine whether a valid MFP command 207 has been specified with the message. The message handler 620 may also determine if the message payload is valid in view of the command. For example, if the command is “play,” but the message payload is only a text message, the message 202 may be invalid. If the message is found to be invalid, the process moves to block 908 and the message is rejected by the MFP device 104. If the message is found valid at decision block 906, the process instead moves to block 910, and the message output is sent to the appropriate destination.

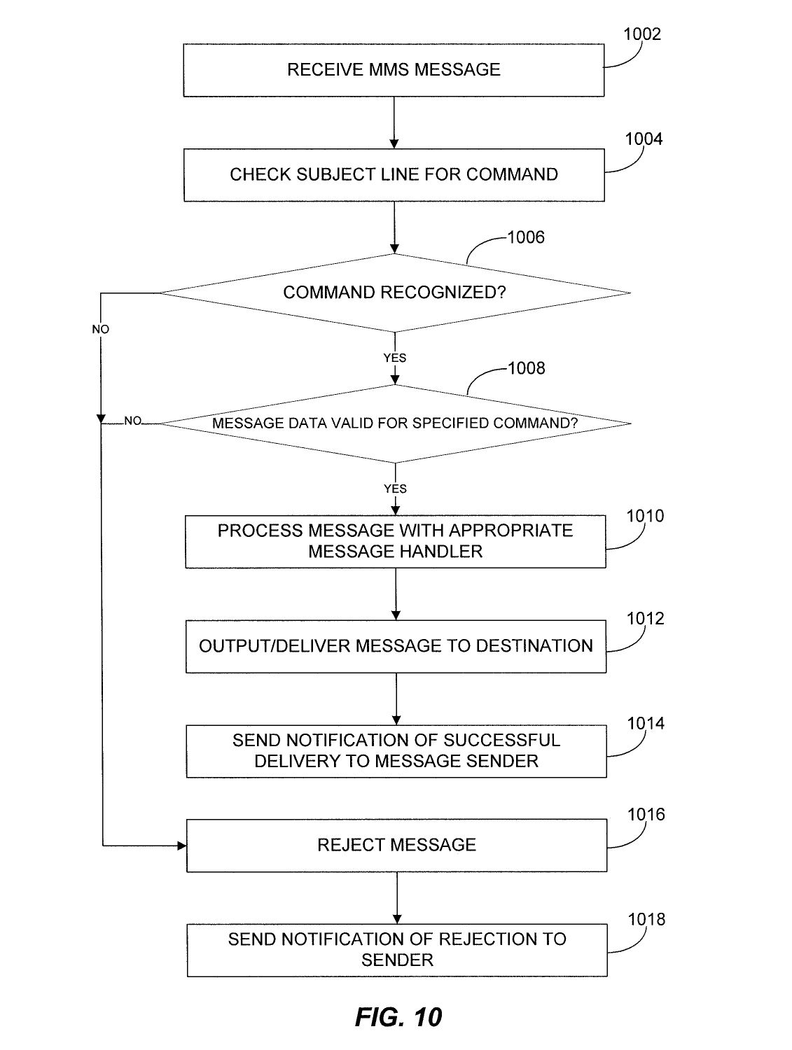

Referring now to FIG. 10, a more detailed flowchart of a message handling process is provided. In this particular example, an MMS message 202 is received and processed by the MFP device 104. The process begins at block 1002, where the MFP device 104 receives a message 202 from the mobile network 102. Next, the process moves to block 1004, where the MFP device determines if an MFP command has been included in the message 202. In some embodiments, the MFP 104 may be configured so determine that a default command should be executed in the absence of a specified command. For example, if a message 202 is received that does not specify a MFP command 207, the MFP 104 may treat such an absence as a “print” command. The process then moves to decision block 1006, where the MFP determines whether the command 207 included in the message is a recognized command. If the command is not recognized, the process jumps to block 1016 and the message is rejected. Once the message has been rejected, a notification of the message rejection may be sent to the sending device 100 over the mobile network 102 at block 1018.

If at decision block 1006, the command 207 is recognized by the MFP 104, the process moves to decision block 1008, where it is determined whether the message payload is valid and/or compatible with the specified command 207. As discussed above in connection with FIG. 9, one example of an incompatibility would be where the command is a “play” command and the message payload is an SMS text message. Another example would be a “display” command that arrives with an audio file. If the message payload is not compatible with the message command 207, the process skips to block 1016 and the message is rejected and a notification is sent to the sending device 100 (at block 1018 as discussed above). If the message payload is determined to be valid, the process moves to block 1010 where the received message 202 is passed to the appropriate message handling function within the message handler 620. Based on the command data 207 in the message 202, the message handling function outputs/delivers the message 202 to its intended output/delivery location at block 1012. Once the message has been output or delivered, the process moves to block 1014, and a notification is sent to the sending device 100 that text message has been successfully transmitted.

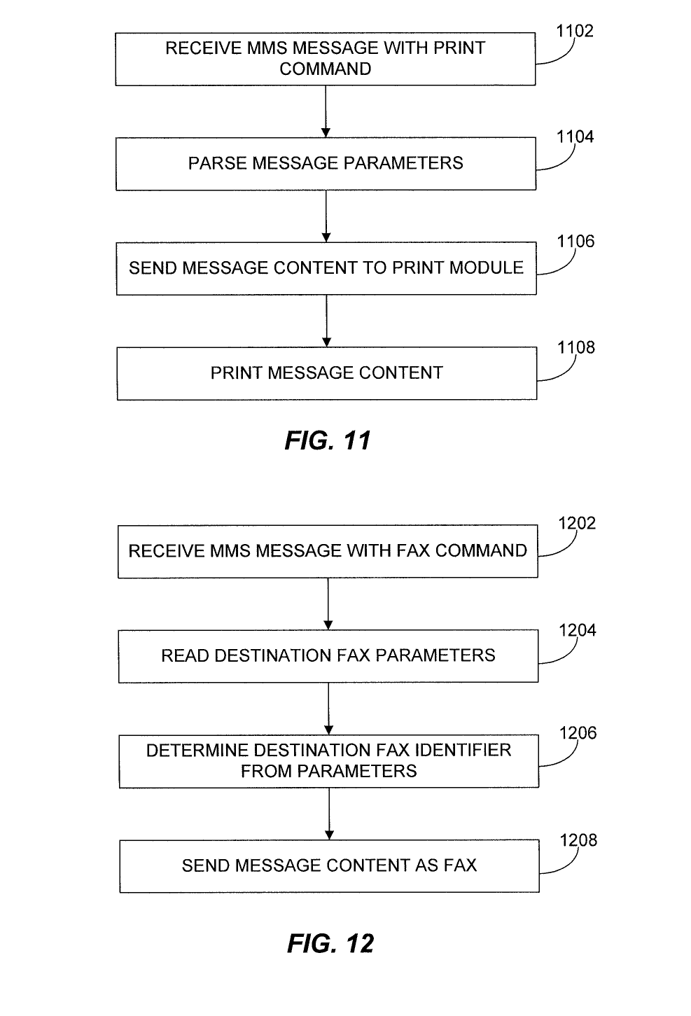

FIGS. 11-15 provide specific examples of how certain types of message payloads may be handled by the MFP device 104 in accordance with various embodiments. Utilizing certain protocols, the user of the sending device 100 is able to input MFP commands 207 into the subject line 206 of a message. In some embodiments, the protocol may take the form of “<command> <option1> <option2> . . . <optionN>”. Thus, an example of a command may be “print letter color 600 dpi”.

FIG. 11 is a flowchart showing an example of the MFP device 104 receiving a message 202 which specifies an MFP print command 207. The process begins at block 1102, where the MFP 104 receives the message 202 from the mobile network 102. The message in this particular example is a print command. As discussed above, the print command may be included in the subject line 206 of the message 202. In some embodiments, the command protocol may allow for the print command to be truncated (e.g., “p letter”) into a single letter to reduce the number of keystrokes necessary to input the message on the device. At block 1104, the MFP device 104 (typically utilizing the message handler 620) parses the MFP command 207. In parsing the MFP command, the message handler 620 typically first identifies the command (in this case “print”) and then determines the print options associated with the print command. Next, at block 1106, the message payload and the print options are sent to the printing module 608 on the MFP device 104, and the message is printed by the device 104 at block 1108.

Turning now to FIG. 12, a flowchart showing an exemplary process of an MFP device 104 handling a fax command is provided. The process begins at block 1202, where the MFP 104 receives the message 202 from the mobile network 102. As discussed above, a message with a fax command included in the subject line 206 may be received via the mobile network interface 602 on the MFP device 104. In some embodiments, the options specified in the MFP command 207 may take advantage of existing data stored in the MFP 104. For example, a fax command typically includes a phone number to which the message 202 data should be faxed (e.g., “fax 949-555-1212”). However, the MFP device 104 may include an address book (or similar capability) that associates fax numbers with names or locations. In these instances, the MFP command 207 included with the message 202 may specify a name or location (e.g., “fax home”) instead of a phone number. Once the message has been received by the MFP device 104, the process moves to block 1204, where the MFP reads the destination fax parameters to determine that a fax command is included in the message 202. At block 1206, the MFP determines the fax number or address to which the message 202 is to be sent. As noted above, this process may include associating a name or location with a fax address by referring to an address book or some other data stored on the MFP device 104. Once the fax destination has been determined by the MFP, the message 202 is provided to the fax module 614, and the fax is sent to the destination address at block 1208.

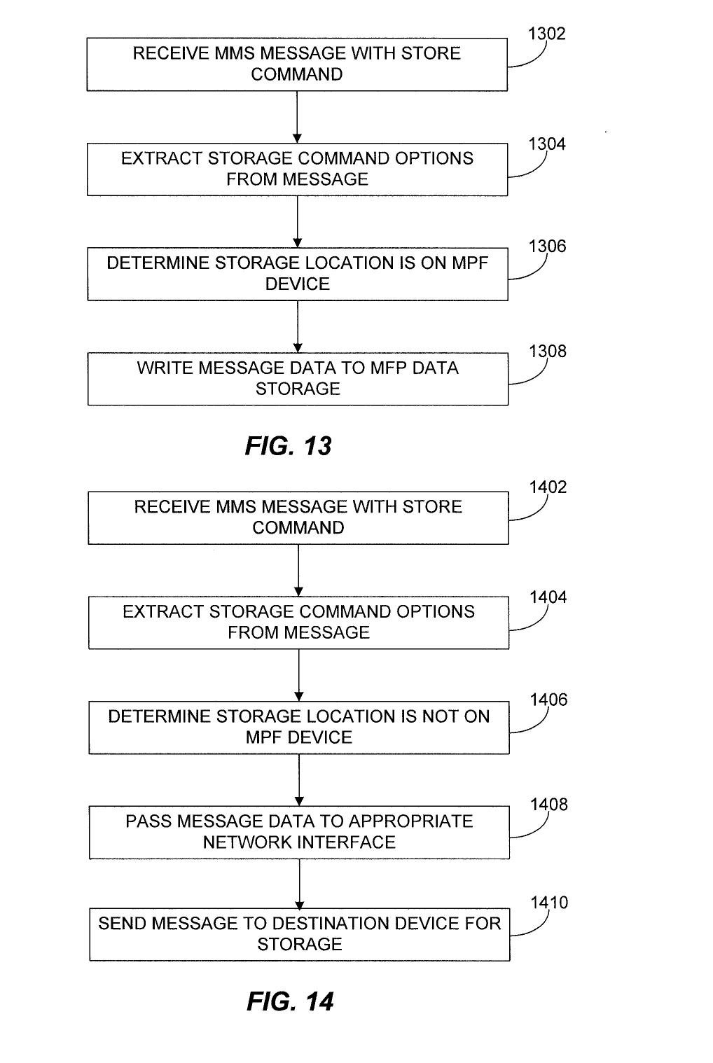

Referring now to FIGS. 13 and 14, two examples of how the MFP 104 may handle store commands are provided. As noted previously, the MFP device 104 may be configured to store data received in a message 202 either in data storage 612 on the MFP device, or in a memory external to the device 104. FIG. 13 provides a specific example of a process by which the MFP 104 receives a message 202 with store command which specifies an internal storage location. The process begins at block 1302, where the MFP device 104 receives the message 202 via the mobile network 102 and its mobile network interface 602. The received message 202 specifies a store command with a storage location indicated as a command option. The process then moves to block 1304, where the MFP 1304 extracts the store command options from the message 202. At block 1306, the MFP 104 determines that the storage location specified in the command option is a location on the MFP device. The MFP 104 then completes the store operation by writing the message data 202 to data storage 612 on the MFP device at block 1308.

Turning now to FIG. 14, a process is shown in which the store command specifies a storage location remote from the MFP device 104. The process begins at block 1402 where the MFP device 104 receives a message 202 with a store command. Next, at block 1404, the MFP 104 extracts the storage command option from the message 202. At block 1406, it is determined that the storage location in the storage command options is not a memory on the MFP device 104. As a result, the MFP device 104 passes the message data to one of its network interface for transfer to the external storage location at block 1408. At block 1410, network interface receives the message data and transmits the message data to the storage location on the external device.

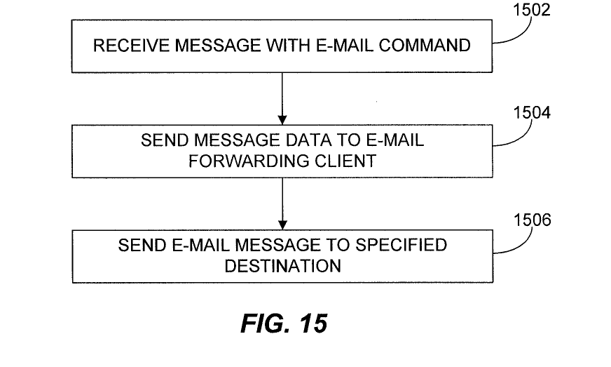

FIG. 15 is a flowchart providing an example of an e-mail command. In processing an e-mail command included with a message, the MFP 104 may act as an automatic forwarder and send the text message to the specified recipient via e-mail. Although some mobile devices 100 may have direct e-mail capability, this embodiment may be useful where a device 100 has only messaging capability (and not e-mail), or where messaging access is cheaper than e-mail access from the device 100. The process begins at block 1502, where the MFP 104 receives a message 202 with “e-mail” specified as the MFP command 207. Next, the MFP 104 passes the received message 202 to the e-mail client 618 on the MFP device 104. The process then moves to block 1506, where the e-mail client 618 then sends the message data to the destination address specified in the e-mail command options of the received message.

Those of skill may recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various embodiments, it may be understood that various omissions, substitutions, and changes in the form and details of a device or process illustrated may be made by those skilled in the art without departing from the spirit of the invention. As may be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A multifunction peripheral device (MFP) comprising:
one or more output modules;
a mobile network interface configured to receive messages sent from a mobile network device, wherein the messages include at least one MFP command; and
a message handling module configured to process the received message and transmit the message to a selected one of the output modules.

2. The multifunction peripheral device of claim 1, wherein the message handling module comprises a command processing function configured to extract MFP command data from the received message.

3. The multifunction peripheral device of claim 2, wherein the output module on the MFP is selected based on the MFP command data.

4. The multifunction peripheral device of claim 2, wherein the MFP command data comprises an MFP command and an MFP command option.

5. The multifunction peripheral device of claim 4, wherein the MFP command is a print command and the MFP command option comprises a dots-per-inch (DPI) value associated with the print command.

6. The multifunction peripheral device of claim 1, wherein the message handling module is further configured to validate the received message by determining if the MFP command and the message are compatible.

7. The multifunction peripheral device of claim 1, wherein the message handling module is further configured to validate the received message by determining if the MFP is capable of performing the MFP command.

8. The multifunction peripheral device of claim 7, wherein the MFP device is configured to send a message to the sending mobile network device confirming receipt of the message.

9. A method of providing messaging services in a multi-function peripheral device (MFP), the method comprising:
receiving from a mobile handheld device a message, the message comprising at least one MFP command;
processing the received message to extract the MFP command; and
performing an output function on the message based on the MFP command.

10. The method of claim 9, further comprising delivering the processed message to an output module of the MFP.

11. The method of claim 9, wherein the message comprises at least one of a simple messaging service (SMS) message, an extended messaging service (EMS) message, and a multimedia message service (MMS) message.

12. The method of claim 11, wherein the message is a MMS message and the output function comprises printing at least a portion of the MMS message.

13. The method of claim 12, wherein the MFP command comprises a print command which specifies an output parameter for the output function.

14. The method of claim 13, wherein the output parameter comprises at least one of an output tray of the MFP, an output color for the print function, a paper size for the output, and a resolution for the output.

15. The method of claim 1, further comprising validating the message by determining if the MFP command and the message are compatible.

16. The method of claim 15, wherein determining if the MFP command and the message are compatible comprises analyzing the type of data included in the message, and determining whether that type of data can be output as requested in the MFP command.

17. The method of claim 1, wherein the MFP command is a fax command comprising fax parameters indicative of a destination location for the fax function of the MFP to send the message content.

18. The method of claim 17, further comprising faxing the message to the destination location.

19. The method of claim 1, wherein the MFP command is a store command comprising storage parameters indicative of a location to store at least some data of the message.

20. The method of claim 19, wherein performing the output function comprises storing at least a portion of the message in the indicated location.

21. The method of claim 20, wherein the location comprises a memory on the MFP device.

22. The method of claim 20, wherein the location comprises a memory on a computing device in communication with the MFP device, and wherein performing the output function further comprises transmitting at least a portion of the message to the computing device.

23. The method of claim 1, wherein the MFP command is an e-mail command comprising parameters indicative of an e-mail recipient for at least a portion of the message.

24. The method of claim 23, wherein performing the output function comprises sending at least a portion of the message to the e-mail recipient.

25. The method of claim 24, wherein the message comprises an MMS message comprising multimedia data, and wherein the MFP command comprises a play command, and wherein performing the output function comprises playing at least a portion of the MMS message.
